(19) United States
(12) Patent Application Publication
(10) Pub. No.: US 2022/0307531 A1
(43) Pub. Date: Sep. 29, 2022

(54) NETTING GRIPPING CLIPS

(71) Applicant: PACIFIC NETTING & FABRICS INC., Pasco, WA (US)

(72) Inventors: Elias Rodriguez, Zillah, WA (US); Guillermo Olivera, Pasco, WA (US)

(21) Appl. No.: 17/210,992

(22) Filed: Mar. 24, 2021

(51) Int. Cl. F16B 5/06; F16B 2/24; F16B 2/10

(52) U.S. Cl. CPC F16B 5/0692; F16B 2/24; F16B 2/10

(57) ABSTRACT

A gripping clip, preferably formed of plastic material, the clip for receiving edge portions of netting or tarp, with a hinged interlock between two mating halves of the clip to receive and grip the netting or tarp. More specifically, the clips are formed of two connected part, joined together by a hinge and by interlocking features. The clip includes a top connected to a base with a hinge, the base has a set of posts extending from the base and the top has a set of post-holes. The top interlocks to the base, with each post of the base received into a post-hole. The netting seats on the clip base, with each post extending through the netting, and the netting retained between the top and base of the clip. The clip also includes a hole to receive a snap-link for attachment to a support.

### TECHNICAL FIELD

This invention pertains to gripping “clips” preferably formed of plastic material, the clips for receiving edge portions of a netting and more particularly to the two-part hinged interlocking of such clips, which can receive and grip the netting. More specifically, the invention relates to an improved two-part hinged clip for gripping netting or tarps, where the clip's parts join together by a hinge and with the aid of interlocking post-and-hole features.

### BACKGROUND OF THE INVENTION

The present invention generally relates to net gripping devices. Nets are used in modern crop cultivation, such as orchards, vineyards, berry and vegetable growing sites, for shade, weather protection, and to shield the crop from birds. Typically, the netting is draped over supports or trellises and affixed to the supports by “tie-downs” along the edges of the netting. The tie-downs can include straps, wires, cables, or strings. Additionally, grommets can also be sewn into or alternatively pressed into the netting, often along fabric edges of the netting. The tie-downs can then be threaded through the grommets, to prevent the tie-downs from ripping out of the netting.

Agricultural labor is increasingly expensive and difficult to acquire. Shortages in harvesting laborers, with needs for increased efficiency requires that even simple equipment or implements used on the farm orchard or vineyard be redesigned or re-engineered to improve their operation, often to perform a multiple of tasks more efficiently than current devices and practices.

The present invention provides an improved netting clip, especially for use in agricultural operations. Additionally, the following disclosure of the present invention will be understood by reference to the following detailed description, taken in conjunction with the accompanying drawings.

### BRIEF DESCRIPTION OF DRAWINGS

FIG. 1 is a perspective view of a gripping clip, according to an embodiment of the invention;

FIG. 2 is a perspective view of a gripping clip with a segment of a netting received into the clip, according to an embodiment of the invention; and

FIG. 3 is a perspective view of a gripping clip with a segment of a netting received into the clip, according to an embodiment of the invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and may include fragmentary views, graphic symbols, diagrammatic or schematic representations. Details that are not necessary for an understanding of the present invention by one skilled in the technology of the invention, or render other details difficult to perceive, may have been omitted.

### DETAILED DESCRIPTION OF SPECIFIC EMBODIMENTS

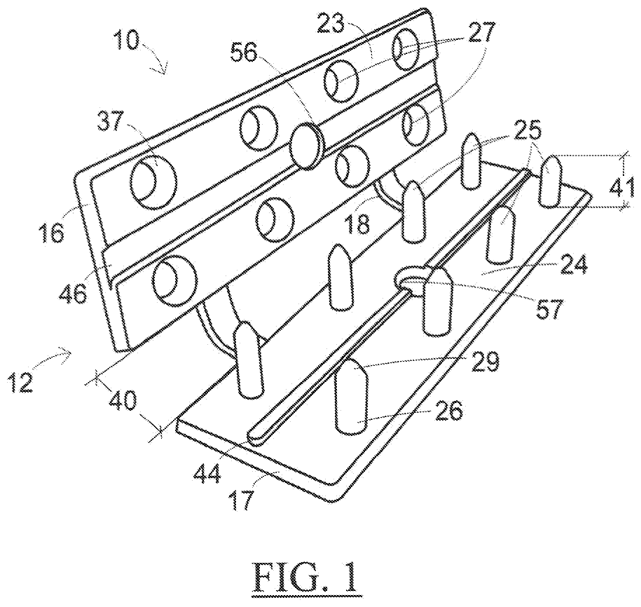

The present invention is a gripping clip, preferably formed of a plastic material, the gripping clip for receiving an edge portion of a netting material. The gripping clip may simply be referred to herein as a “clip.” FIGS. 1 through 3 show a preferred embodiment of the clip 10 having features according the present invention, with FIG. 1 illustrating the clip in an open-clip position 12, the clip having a clip top 16 connected to a clip base 17 with a clip hinge 18 connecting the clip top to the clip base. The two-part, hinged clip is formed of a substantially flat material 19, such as a thermal form-able resin, a thin plastic sheet or strip, or optionally a metal.

Most preferably, the clip 10 may be any resilient plastic material, and preferably a thermoplastic material, such as a polystyrene or a polyethylene. Fibrous materials can also be used for the clip, or incorporated into a plastic to form the clip, such as a wood or mineral fiber. Additionally, the clip material can be recycled or recyclable. Also alternatively, the clip can be a biodegradable, or water soluble material, or include any other material known to a person skilled in the art of plastic article manufacture. Advantageously, the clip of the present invention can be formed of a softer or more flexible rubber containing, or a rubber-like material.

Preferably, each clip 10 of the present invention is formed by a conventional thermal injector or thermal press, to produce the clip in a single piece that includes the clip top 16 connected to the clip base 17 by the clip hinge 18. This thermal injection manufacturing process is preferable in that it allows the clip to be formed from a wide variety of materials, as discussed above.

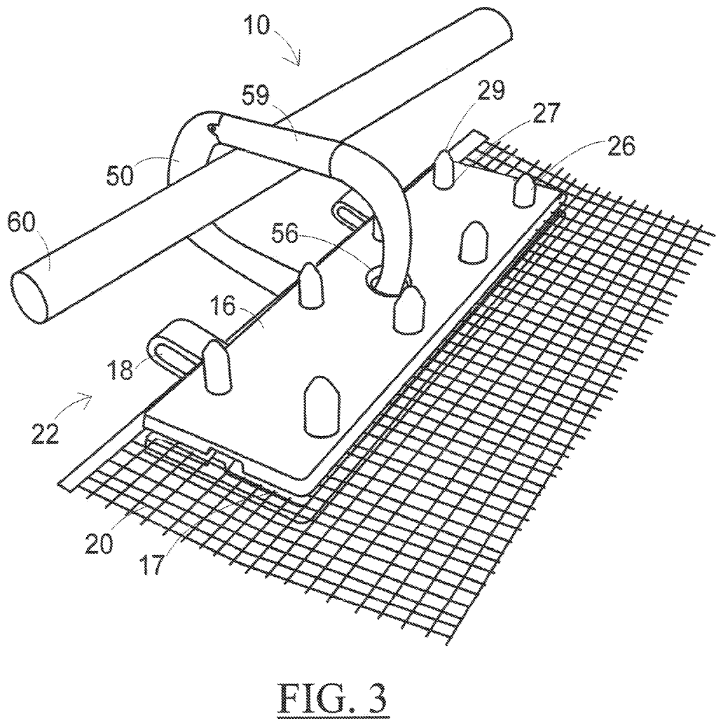

The clip top 16 mates to the clip base to grip a netting material 20, as shown in FIG. 3, with the use of the clip hinge 18 to position the clip in a closed-clip position 22. The clip top has a clip top face 23, and the clip base has a clip base face 24 that matches up to the clip top face when the clip is in the closed-clip position, with the netting material held between the clip top and the clip base.

Interlocking the clip top 16 to the clip base 17 is accomplished by a set of multiple posts 25 that extend from clip face base 24 of the clip base, as shown in FIG. 1, with each post 26 in the set of multiple posts, receivable into a post-hole 27 in the clip top. As preferred, eight posts are included in the clip base, spaced apart as shown in FIG. 1. However, any number of the posts at any spacing could be utilized for the set of multiple posts, depending on the overall size desired for the clip, and the strength of the grip needed for gripping the netting material 20. It is conceived that as few as two posts could serve to grip a certain netting material, while up to twenty posts could be used in a closely spaced pattern for gripping other conventional netting material, if desired.

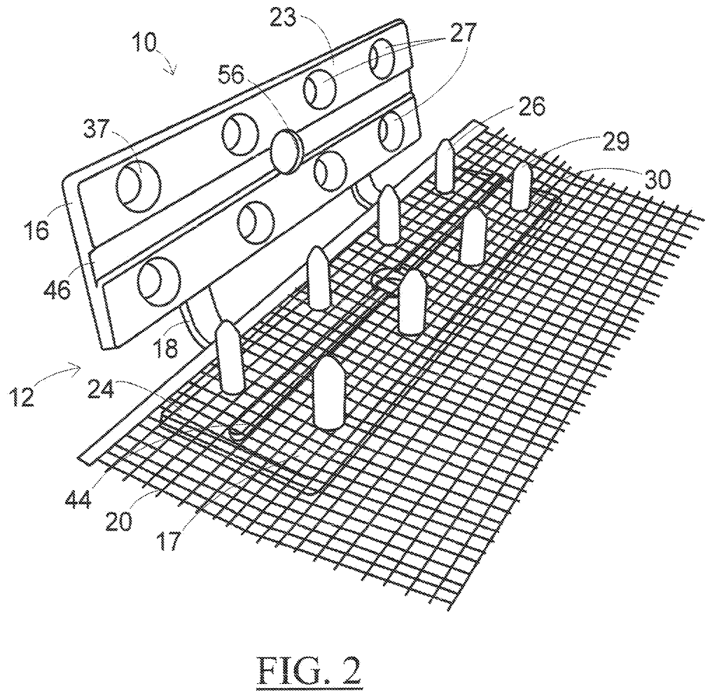

Most preferably, each post 26 of the set of multiple posts 25 terminates with a post point 29, that is able to penetrate the netting material, as shown in FIG. 2. The netting material 20 seats upon the clip base face 24 of the clip base 17, with each post extending through a gap in the netting 30. More generally, the netting material is any bird netting, shade netting, weather netting, or potentially a tarp, especially when the tarp includes a netting reinforcement, where each post 26 of the set of multiple posts can penetrate through the tarp with a minimum of tearing beyond any hole made in the tarp by the set of multiple posts.

Also preferably, as shown in FIGS. 1 and 2, each post-hole 27 in the clip top 16 includes a countersunk hole opening 37 surrounding each of the post-holes to better receive each post 26 of the set of multiple posts 25, as the clip hinges on the clip hinge 18 to the closed-clip position 22. As shown in FIG. 3, each countersunk hole opening surrounds each of the post-holes on the clip top face 23.

To best operate the clip 10, it is preferred that the clip hinge 18 has a hinge length 40, which is the distance the clip top 16 is separated from the clip base 17, and that the hinge length is approximately equal to or slightly greater than a post length 41, which is the distance each post 26 of the set of multiple posts 25 extends from the clip base, as shown in FIG. 1. A most preferred hinge length is approximately 1.3 cm (0.5 in) for use with each post having the post length of approximately 1.0 cm (0.39 in).

An additional gripping feature in a preferred clip 10 of the present invention is a central rib 44 in the clip base face 24 of the clip base 17, as shown in FIG. 1. The central rib preferably mates with a central channel 46 in the clip top face 23 of the clip top 16, also shown in FIG. 1. Most preferably, the central rib is received into the central channel and adds gripping power to the clip when the netting material is received within the clip, and the clip is then snapped to the closed-clip position.

The clip 10 of the present invention greatly reduces the potential of the netting material 20 ripping out or tearing away from the tie-down or tie elements employed to secure the netting to any supporting structure. Each post 26 of the multiple of posts 25 is received into the post-holes 27 grip the netting material as shown in FIG. 3, with the hinged closure of the clip able to be reopened to the open clip position 12, if desired. With this feature, the clip can be reused, or the netting material is re-purposed after its use in the clip is no longer desired.

An additional preferred feature of the clip 10 is shown in FIG. 3, with a snap-link 50 received into the clip. A top link-hole 56 can be included in the clip top 16, and a base link-hole 57 can be included in the clip base 17, as shown in FIG. 1. The snap-link is a standard type of carabineer or clasp with a spring gate 59, as is a well-known hardware item. The snap-link can be threaded through the clip when the clip is in the closed clip position, as shown in FIG. 3. Any multiple of the gripping clips can be attached to a support 60 with the snap-link. The support can be any conventional type of supporting trellis, frame, support, pole, or stake as employed to support the netting material.

The terms “approximately” or “approximate” are employed herein throughout, including this detailed description and the attached claims, with the understanding that is denotes a level of exactitude commensurate with the skill and precision typical for the particular field of endeavor, as applicable.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A clip for gripping and retaining a netting material, the clip comprising:
a clip hinge;
a clip top connects to a clip base with the clip hinge;
the clip base having a set of posts, the set of posts extends from the clip base, and each post of the set of posts terminates with a post point;
the clip top having a set of post-holes within the clip top;
the clip top interlock-able to the clip base in a closed-clip position, with each post in the set of posts of the clip base receivable into a post-hole in the clip top in the closed-clip position;
the clip hinge-able about the clip hinge from an open-clip position to the closed-clip position; and
with the netting material seats on the clip base, the netting material penetrate-able with the post point, and each post of the set of posts extends through the netting material seated on the clip base.

2. The clip of claim 1, wherein each post-hole in the clip top includes a countersunk hole opening, the countersunk hole opening surrounds each post-hole to better receive each post of the set of posts as the clip hinges on the clip hinge, from the open-clip position to the closed-clip position.

3. The clip of claim 1, additionally comprising:
a central rib in the clip base and a central channel in the clip top;
the central rib of the clip base is received into the central channel of the clip top, when the clip is in the closed-clip position; and
the netting material is gripped between the central rip band the central when the clip is in the closed-clip position.

4. The clip of claim 1, additionally comprising:
the clip top having a top link-hole;
the clip base having a base link-hole;
a snap-link received into the clip, and the snap-link threads through the top link-hole and the base link-hole when the clip is in the closed-clip position; and
the snap-link is attachable to a support.

5. The clip of claim 1, wherein set of posts in the clip base, consists of eight posts, the set of post-holes within the clip top consists of eight post holes; and
the eight posts mate into the eight post holes, when the clip is in the closed-clip position.

6. The clip of claim 1, wherein the clip is a resilient material form-able in a thermal press, to produce the clip in a single piece, and the single piece of the clip includes the clip top connected to the clip base by the clip hinge.

7. The clip of claim 6, wherein the resilient material of the clip is a fibrous material.

8. The clip of claim 6, wherein the resilient material of the clip is a polyethylene.

9. The clip of claim 6, wherein the resilient material of the clip is a polystyrene.

10. The clip of claim 1, wherein the clip is formed from a metal material.

11. A clip for gripping and retaining a netting material, the clip comprising:
a clip hinge, a clip top, a clip base, and the clip top connects to a clip base with the clip hinge;
the clip top hinge-able about the clip base from an open-clip position to a closed-clip position;
the clip top having a clip top face, the clip base having a clip base face, and the clip top face meets against the clip base face when the clip is in the closed-clip position;
the clip base having a set of posts, the set of posts extends from the clip base face of the clip base, and each post of the set of posts terminates with a post point;
the clip top having a set of post-holes within the clip top;
the clip top interlock-able to the clip base in the closed-clip position, with each post in the set of posts of the clip base receivable into a post-hole in the clip top in the closed-clip position; and the netting material seats on the clip base, the netting material penetrate-able with the post point, each post of the set of posts extends through the netting material seated on the clip base, and the netting material retained between the clip top face and the clip base face in the closed-clip position.

12. The clip of claim 11, wherein each post-hole in the clip top includes a countersunk hole opening, the countersunk hole opening surrounds each post-hole to better receive each post of the set of posts as the clip hinges on the clip hinge, from the open-clip position to the closed-clip position.

13. The clip of claim 11, additionally comprising:
a central rib in the clip base face of the clip base and a central channel in the clip top face of the clip top;
the central rib of the clip base is received into the central channel of the clip top, when the clip is in the closed-clip position; and
the netting material is gripped between the central rip band the central when the clip is in the closed-clip position.

14. The clip of claim 11, additionally comprising:
the clip top having a top link-hole;
the clip base having a base link-hole;
a snap-link received into the clip, and the snap-link threads through the top link-hole and the snap-link threads through the base link-hole, when the clip is in the closed-clip position; and
the snap-link is attachable to a support.

15. The clip of claim 11, wherein set of posts in the clip base, consists of eight posts, the set of post-holes within the clip top consists of eight post holes; and
the eight posts mate into the eight post holes, when the clip is in the closed-clip position.

16. The clip of claim 11, wherein the clip is a resilient material form-able in a thermal press, to produce the clip in a single piece, and the single piece of the clip includes the clip top connected to the clip base by the clip hinge.

17. The clip of claim 16, wherein the resilient material of the clip is a fibrous material.

18. The clip of claim 16, wherein the resilient material of the clip is a polyethylene.

19. The clip of claim 16, wherein the resilient material of the clip is a polystyrene.

20. The clip of claim 11, wherein the clip is formed from a metal material.
